(19) United States
(12) Patent Application Publication
(10) Pub. No.: US 2005/0242768 A1
(43) Pub. Date: Nov. 3, 2005

(54) Method and apparatus for sharing battery charging resources

(76) Inventors: Amol S. Pandit, Greeley, CO (US); Daniel J. Byrne, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/835,575

(22) Filed: Apr. 28, 2004

(51) Int. Cl. H02J 7/00

(52) U.S. Cl. 320/107

(57) ABSTRACT

Devices sharing battery charging resources coordinate use of a high-current charging mode through use of a message protocol between the devices. While a high-priority device is using the high-current charging mode, the other devices may continue charging in a reduced-current charging mode.

### FIELD OF THE INVENTION

The present invention relates generally to battery recharging systems and more specifically to techniques for sharing battery charging resources among multiple electronic devices.

### BACKGROUND OF THE INVENTION

In some applications, multiple rechargeable electronic devices share battery charging resources (e.g., the devices share a single AC/DC adapter). If the devices attempt to recharge their batteries simultaneously using a high-current recharging mode, the single power supply may be unable to supply sufficient charge current.

Ignoring this problem results in one or more devices not recharging properly. Increasing the available charging current requires a redesign of the power supply, which may increase its cost and cause delay in its qualification for the marketplace. Using multiple power supplies also increases cost and increases the complexity of using the devices for the consumer, leading to possible confusion.

It is thus apparent that there is a need in the art for an improved method and apparatus for sharing battery charging resources.

### SUMMARY OF THE INVENTION

A method for sharing battery charging resources is provided. A system and an apparatus for carrying out the method are also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of the recharging profile of a lithium ion battery in accordance with an illustrative embodiment of the invention.

FIG. 2 is a functional block diagram of a system in accordance with an illustrative embodiment of the invention.

FIGS. 3A and 3B are a flowchart of a method for sharing battery charging resources from the point of view of a docking station in accordance with an illustrative embodiment of the invention.

FIG. 3C is a flowchart of a method for sharing battery charging resources from the point of view of a rechargeable digital camera in accordance with an illustrative embodiment of the invention.

FIGS. 4A and 4B are tables showing protocol message formats in accordance with an illustrative embodiment of the invention.

FIG. 4C is a table showing the format of a charge-status byte within the protocol messages shown in FIGS. 4A and 4B in accordance with an illustrative embodiment of the invention.

### DETAILED DESCRIPTION OF THE INVENTION

The sharing of battery charging resources by multiple electronic devices may be effectively coordinated through use of a message protocol among the devices. When a device having priority in the use of a high-current charging mode needs to recharge in the high-current charging mode, it can notify the other devices via the message protocol. Upon receiving an acknowledgement from the other devices, the high-priority device can then recharge in the high-current charging mode while the other devices continue to recharge in a reduced-current charging mode. When the high-priority device has completed the high-current recharging phase, it may notify the other devices via the message protocol, thus freeing up the high-current charging mode for a lower-priority device.

Although the invention is described in the context of two devices, a digital camera and a docking station with a secondary charging bay, that share battery charging resources, the principles of the invention are applicable to any rechargeable electronic device and the sharing of battery charging resources by greater than two such devices.

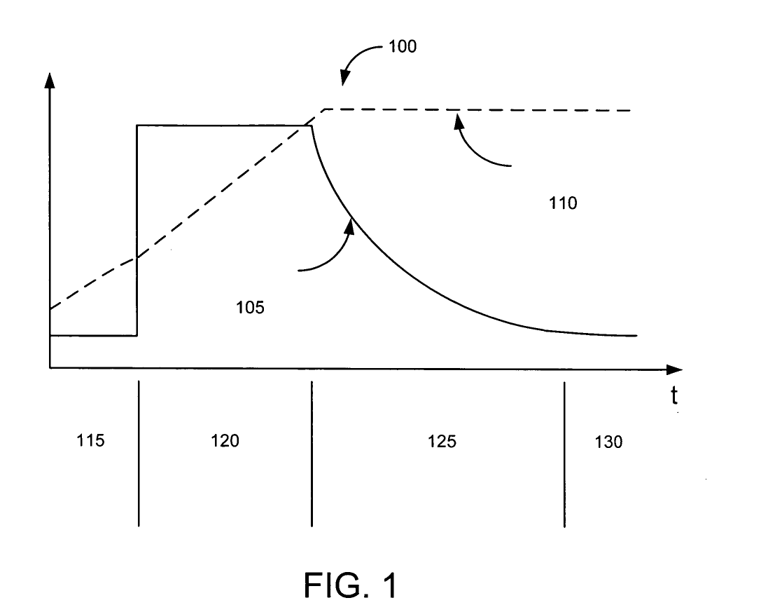

FIG. 1 is an illustration of the recharging profile of a lithium ion battery in accordance with an illustrative embodiment of the invention. Throughout this detailed description, lithium ion battery technology is assumed. However, the principles of the invention may be applied to other battery chemistries. The recharging profile shown in FIG. 1 is intended to be merely illustrative and may differ for other lithium ion batteries or for other battery chemistries. In FIG. 1, charge current 105 and charge voltage 110 are graphed as a function of time and superimposed on a common pair of axes. The process of recharging the lithium ion battery may be divided into four phases corresponding to four distinct charging modes (a single reference numeral will be used to refer to each phase and its corresponding mode): (1) pre-charge 115, (2) current regulation 120, (3) voltage regulation 125, and (4) taper 130. Pre-charge phase 115 and taper phase 130 employ a relatively low level of charge current. For example, pre-charge phase 115 may prepare a completely depleted battery for recharging. Current-regulation phase 120 employs a constant and relatively high level of charge current, and the charge voltage ramps up approximately linearly during that phase. During voltage-regulation phase 125, charge current 105 gradually diminishes as the charge voltage 110 remains approximately constant.

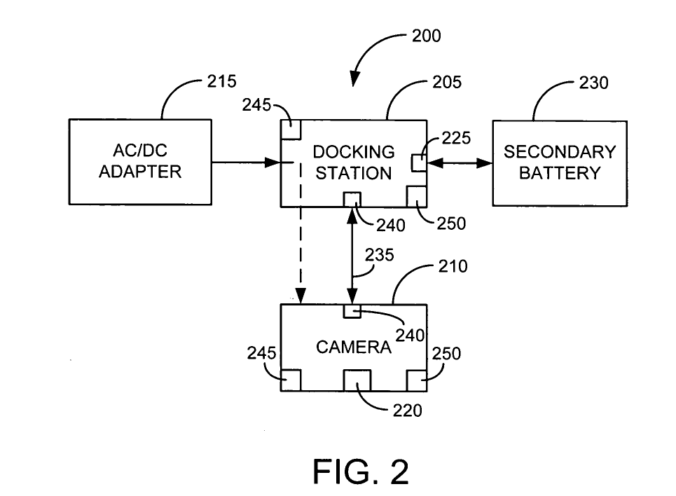

FIG. 2 is a functional block diagram of a system 200 in accordance with an illustrative embodiment of the invention. System 200 comprises docking station 205, rechargeable digital camera (“digital camera”) 210, and AC/DC adapter 215. Digital camera 210 may have an internal rechargeable battery 220, and docking station 205 may have a secondary charging bay 225 for recharging secondary battery 230. Docking station 205 and digital camera 210 may communicate over communication link 235 when digital camera 210 is connected (“docked”) with docking station 205. For example, communication link 235 may be an RS-232 serial connection or any other suitable communication link, which may be hard-wired or wireless. Docking station 205 and digital camera 210 may each include a communication interface 240 to facilitate communication link 235. Also, docking station 205 and digital camera 210 may each include a controller (e.g., a microprocessor) 245 to control its functions and its interactions with other devices. Further, docking station 205 and digital camera 210 may each include battery charging protocol logic 250. Battery charging protocol logic 250 may define and control a message protocol between docking station 205 and digital camera 210 for coordinating the sharing of battery charging resources (i.e., AC/DC adapter 215). In an illustrative embodiment, battery charging protocol logic 250 comprises firmware executed by controller 245. In general, battery charging protocol logic 250 may be implemented in hardware, firmware, software, or any combination thereof.

In FIG. 2, docking station 205 and digital camera 210 share AD/DC adapter 215. In an illustrative embodiment, AC/DC adapter 215 provides a 3.3-V DC supply at a maximum of 2.5 A. Simultaneously recharging both secondary battery 230 and internal battery 220 in current-regulation mode 120 may approach the limits of AC/DC adapter 215. This conflict may be mitigated by coordinating the use of AC/DC adapter 215 by docking station 205 and digital camera 210 through use of a message protocol between the two devices via communication link 235. Such a message protocol may be configured to give one device priority over the other in the use of current-regulation mode 120. In the description that follows, digital camera 210 is given priority over docking station 205. In other embodiments, however, this priority may be reversed.

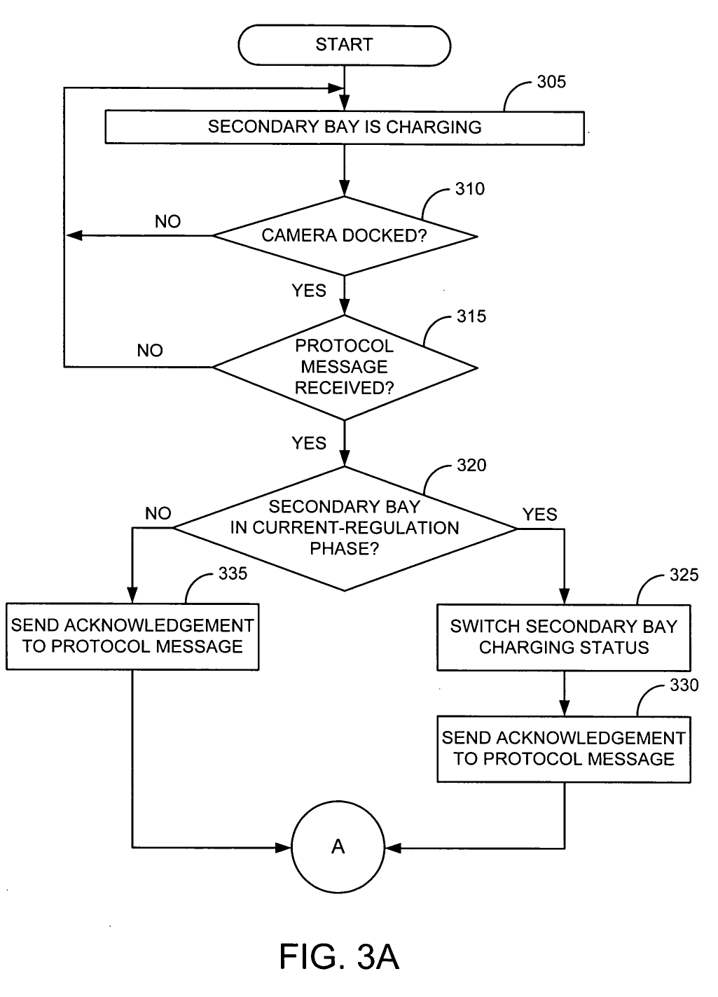

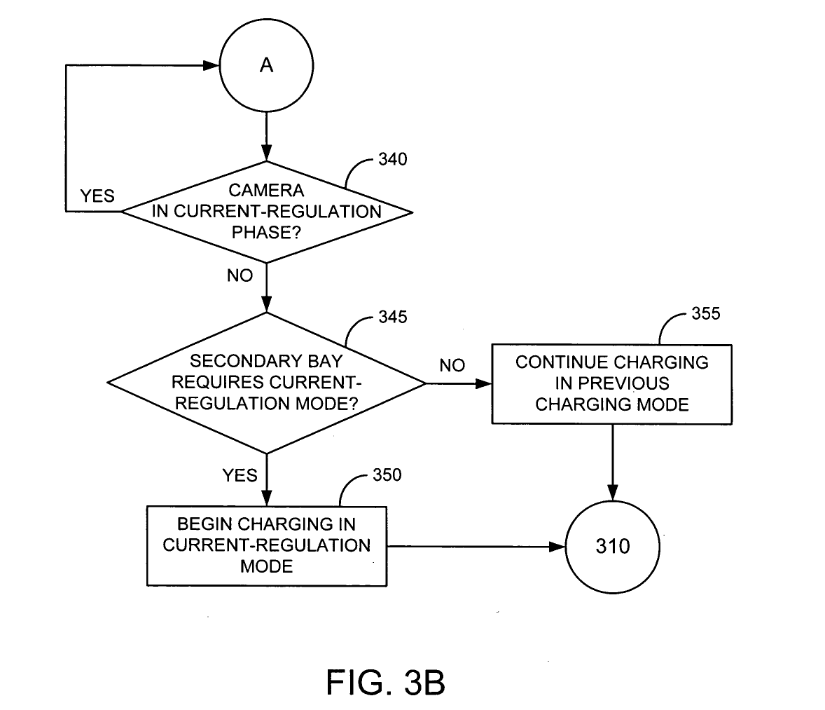

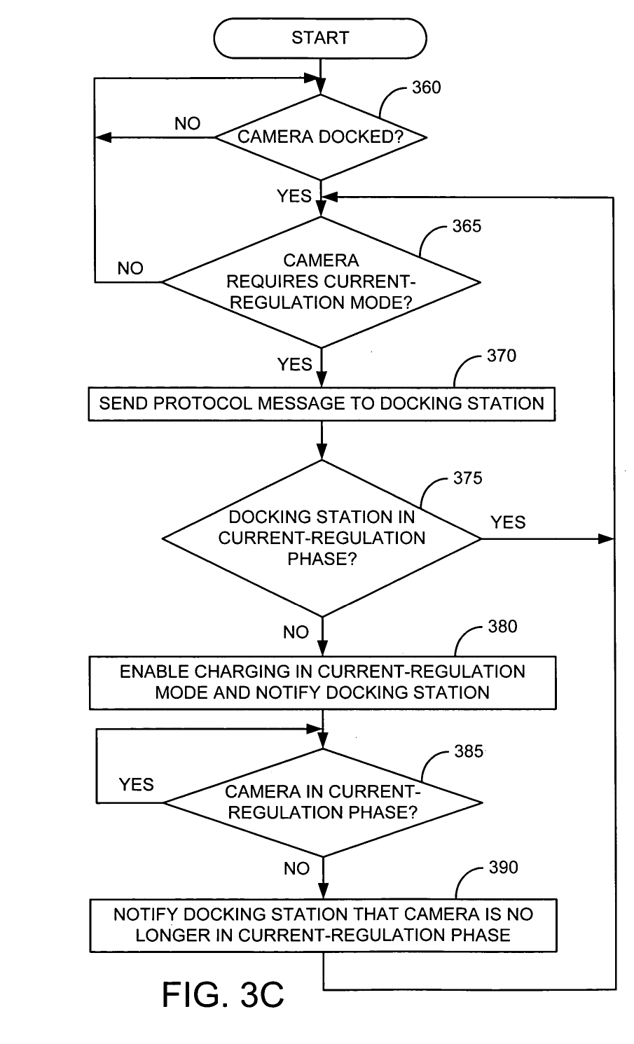

FIGS. 3A and 3B are a flowchart of a method for sharing battery charging resources from the point of view of docking station 205 in accordance with an illustrative embodiment of the invention. At 305, secondary battery 230 in secondary charging bay 225 of docking station 205 is charging. Once digital camera 210 is docked with docking station 205 at 310 and a protocol message requesting use of current-regulation mode 120 is received from digital camera 210 at 315, the process proceeds to 320. If, at 320, docking station 205 is charging secondary battery 230 in current-regulation mode 120, the charging status of secondary charging bay 225 is switched to a reduced-current charging mode (e.g., “trickle” charge) at 325, and docking station 205 sends an acknowledgement message to digital camera 210 at 330. If, at 320, docking station 205 is not charging secondary battery 230 in current-regulation mode 120, docking station 205 simply sends the acknowledgement message to digital camera 210 at 335. At 340, internal battery 220 of digital camera 210 may be recharged in current-regulation mode 120. Once the current-regulation phase 120 of internal battery 220 is complete, the process proceeds to 345. If docking station 205 requires current-regulation mode 120 at 345, secondary battery 230 is recharged in current-regulation mode 120 at 350, and the process returns to 310. Otherwise, secondary battery 230 continues to recharge in its previous charging mode, and the process likewise returns to 310.

FIG. 3C is a flowchart of a method for sharing battery charging resources from the point of view of digital camera 210 in accordance with an illustrative embodiment of the invention. The method shown in FIG. 3C corresponds to that in FIGS. 3A and 3B except for the difference in point of view. If digital camera 210 is docked with docking station 205 at 360 and digital camera 210 requires current-regulation mode 120 at 365, digital camera 210 may send a protocol message to docking station 205 at 370 requesting use of current-regulation mode 120. If docking station 205 is charging secondary battery 230 in current-regulation mode at 375, digital camera 210 may wait until docking station 205 has switched secondary charging bay 225 to a reduced-current charging mode and has sent an acknowledgement to digital camera 210 (see steps 330 and 335 in FIG. 3A). At 380, digital camera 210 may begin charging internal battery 220 in current-regulation mode 120, and digital camera 210 may notify docking station 205 of its change in charging status via a protocol message. Once the current-regulation phase 120 of internal battery 220 is complete at 385, digital camera 210 may notify docking station 205 via a protocol message that digital camera 210 no longer requires use of current-regulation mode 120. The process may then return to 365.

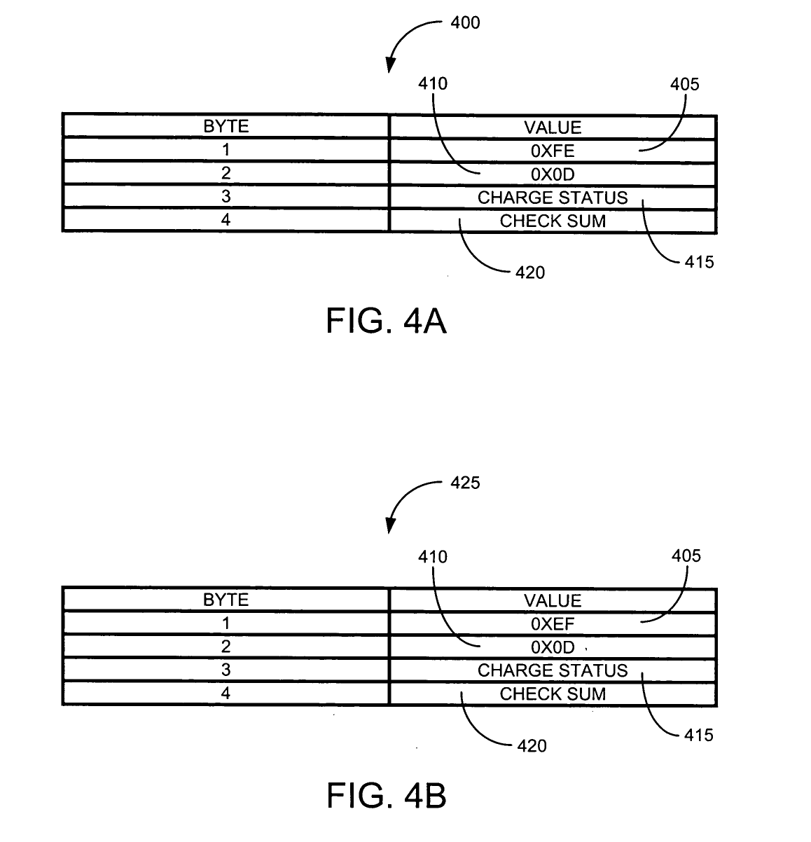

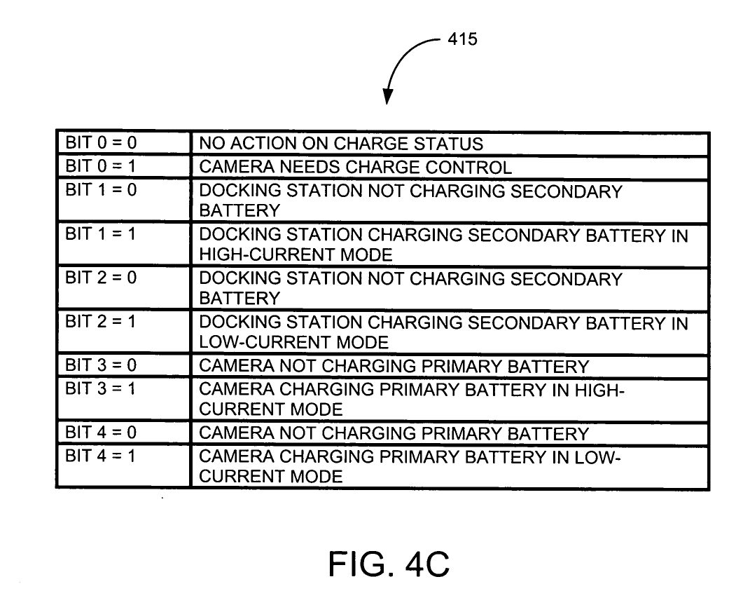

The message protocol between docking station 205 and digital camera 210 may take on a variety of forms, all of which are considered to be within the scope of the invention as claimed. One illustrative implementation is shown in FIGS. 4A-4C.

FIGS. 4A and 4B show formats for protocol messages sent by digital camera 210 and docking station 205, respectively, in accordance with an illustrative embodiment of the invention. In this illustrative embodiment, digital camera 210 is a master device, and docking station 205 is a slave device (i.e., only digital camera 210 may initiate communication between the two devices; docking station 205 merely responds to digital camera 210). As pointed out above, however, these roles may be reversed in other embodiments.

In FIG. 4A, protocol message 400 from digital camera 210 to docking station 205 comprises four bytes (32 bits total). Start byte 405 is shown in FIG. 4A with the arbitrary hexadecimal value of 0×FE. Command number 410 identifies protocol message 400 as a charge-control command in a larger protocol scheme that may include other types of messages sent between digital camera 210 and dockings station 205. Charge status byte 415 may be used to control the mode in which the respective devices recharge. Check sum 420 may be used to detect transmission errors in protocol message 400. The format of protocol message 425 sent from docking station 205 to digital camera 210 is similar to protocol message 400, except that start byte 405 is different (shown in FIG. 4B with the arbitrary hexadecimal value of 0×EF).

FIG. 4C is an example of how charge status byte 415 may be implemented in accordance with an illustrative embodiment of the invention. In the example of FIG. 4C, only five bits of charge status byte 415 are used, leaving three other bits for future expansion. The five bits of charge status byte 415 may be used to indicate the charging status of the two devices and to give priority in the use of current-regulation mode 120 to one of the devices (digital camera 210 in this example). As mentioned above, priority in the use of current-regulation mode 120 may be reversed in other embodiments.

The protocol messages shown in FIGS. 4A-4C may be generated, transmitted, received, and interpreted by battery charging protocol logic 250 in each respective device.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for sharing battery charging resources between a first device and a second device, comprising:
electrically connecting the first device and the second device with the battery charging resources, the first device and the second device being in communication with each other; and
coordinating use of the battery charging resources by the first device and the second device through use of a message protocol between the first device and the second device.

2. The method of claim 1, wherein the message protocol gives the first device priority over the second device in the use of a current-regulation charging mode until the first device has completed a current-regulation charging phase.

3. The method of claim 2, wherein the second device continues to charge in a reduced-current charging mode while the first device is in the current-regulation charging phase.

4. The method of claim 2, wherein coordinating use of the battery charging resources by the first device and the second device through use of a message protocol between the first device and the second device comprises:
sending a message from the first device to the second device informing the second device that the first device requires use of the current-regulation charging mode;
switching the second device to a reduced-current charging mode;
sending an acknowledgement from the second device to the first device; and
charging the first device in the current-regulation charging mode.

5. The method of claim 4, further comprising:
switching the first device to a voltage-regulation charging mode, when the first device has completed the current-regulation charging phase;
sending a command from the first device to the second device informing the second device that the first device no longer requires use of the current-regulation charging mode; and
switching the second device to the current-regulation charging mode.

6. The method of claim 2, wherein the first device is a digital camera and the second device is a docking station, the docking station having a secondary charging bay to charge a secondary battery.

7. The method of claim 2, wherein the first device is a docking station and the second device is a digital camera.

8. The method of claim 1, wherein the battery charging resources comprise a single AC/DC adapter.

9. A system, comprising:
battery charging resources;
a first device and a second device, the first device and the second device being electrically connected with the battery charging resources, the first device and the second device being in communication with each other; and
wherein the first device and the second device are configured to coordinate use of the battery charging resources by the first device and the second device through use of a message protocol between the first device and the second device.

10. The system of claim 9, wherein the message protocol gives the first device priority over the second device in the use of a current-regulation charging mode until the first device has completed a current-regulation charging phase.

11. The system of claim 10, wherein the second device is configured to continue charging in a reduced-current charging mode while the first device is in the current-regulation charging phase.

12. The system of claim 10, wherein the system is programmed to perform the following method:
sending a message from the first device to the second device informing the second device that the first device requires use of the current-regulation charging mode;
switching the second device to a reduced-current charging mode;
sending an acknowledgement from the second device to the first device; and
charging the first device in the current-regulation charging mode.

13. The system of claim 12, wherein the method further comprises:
switching the first device to a voltage-regulation charging mode, when the first device has completed the current-regulation charging phase;
sending a command from the first device to the second device informing the second device that the first device no longer requires use of the current-regulation charging mode; and
switching the second device to the current-regulation charging mode.

14. The system of claim 10, wherein the first device is a digital camera and the second device is a docking station, the docking station having a secondary charging bay to charge a secondary battery

15. The system of claim 10, wherein the first device is a docking station and the second device is a digital camera.

16. The system of claim 9, wherein the battery charging resources comprise a single AC/DC adapter.

17. A device, comprising:
a communication interface to communicate with an external device;
a rechargeable battery; and
battery charging protocol logic to control charging of the rechargeable battery, the battery charging protocol logic being configured to send messages to and receive messages from the external device via the communication interface, the messages coordinating use of battery charging resources shared by the device and the external device.

18. The device of claim 17, wherein the battery charging protocol logic is configured to give the device priority over the external device in the use of a current-regulation charging mode until the device has completed a current-regulation charging phase.

19. The device of claim 18, wherein the battery charging protocol logic is configured such that the external device continues to charge in a reduced-current charging mode while the device is in the current-regulation charging phase.

20. The device of claim 18, wherein the device is a digital camera and the external device is a docking station, the docking station having a secondary charging bay to charge a secondary battery

21. The device of claim 18, wherein the device is a docking station and the external device is a digital camera.

22. The device of claim 17, wherein the rechargeable battery is a lithium ion battery.

23. A device, comprising:
means for communicating with an external device; and
means for controlling charging of a rechargeable battery, the means for controlling charging of a rechargeable battery being configured to send messages to and receive messages from the external device via the means for communicating with an external device, the messages coordinating use of battery charging resources shared by the device and the external device.

24. The device of claim 23, wherein the means for controlling charging of a rechargeable battery is configured to give the device priority over the external device in the use of a current-regulation charging mode until the device has completed a current-regulation charging phase.

25. The device of claim 18, wherein the means for controlling charging of a rechargeable battery is configured such that the external device continues to charge in a reduced-current charging mode while the device is in the current-regulation charging phase.
